(19) United States
(12) Patent Application Publication
(10) Pub. No.: US 2009/0019170 A1
(43) Pub. Date: Jan. 15, 2009

(54) SYSTEM AND METHOD FOR SECURE COMMUNICATION CONFIGURATION

(76) Inventors: Felix Immanuel Wyss, Bloomington, IN (US); Gregory P. Cunningham, Indianapolis, IN (US); Michael D. Snyder, Noblesville, IN (US); Michael L. Szilagyi, Fishers, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/774,845

(22) Filed: Jul. 9, 2007

(51) Int. Cl. G06F 15/16; H04L 9/00

(52) U.S. Cl. 709/229

(57) ABSTRACT

A communication system including a routing server and gateway server through which digital communication sessions are established along selected network routes based upon security requirements is disclosed. A digital communication request having a security level required is transmitted to a routing server. The routing server then determines a route, if available, having a route security rating sufficient for the specified communication and initiates the communication using the gateway server. The route security score is calculated based upon a table of security ratings associated with a plurality of connected networks segments which comprise a digital communication network.

### FIELD OF THE INVENTION

The present invention generally relates to telecommunication systems and methods as well as communication security. More particularly, but not exclusively, the present invention pertains to a system and method for providing and maintaining communication trust scores for a plurality of communication paths, including the function of ensuring that a digital communication occurs over a network path having the requisite security level.

### BACKGROUND

With the emergence of digital communication, such as VoIP, security hasn't been a particularly important topic. In the past, most IP traffic remained on local and wide area enterprise networks, which were relatively secure and protected from the public Internet. But as digital communication usage is becoming widespread and Internet telephony is coming into play, enterprises and home users are becoming subject to the same security risks that have affected data networks for decades, thus opening the door to a whole new realm of security risks. This is largely due to the fact that next-generation voice networks are IP-based and the IP protocols were designed for best-effort data transport.

Currently, digital communication traffic over the Internet is mostly unencrypted. As such, anyone with network access can listen in on conversations. This enables an eavesdropper to tap audio conversations in an unsecured environment. However, in the corporate or call center world, these communications may contain valuable business information, credit card numbers, or other information that must be secured from public access. Other problems exist, such as masquerading, man-in-the-middle attacks, etc.

VoIP traffic can be broken into call signaling, call control, and audio communications. Depending on the VoIP protocol and policies used, these communications may use either one channel or many different channels, which are TCP/UDP connections between two network elements. From a security point of view, all of these connections may need to be secured, i.e. authenticated and encrypted. Other mechanisms that may provide security include authorization, authentication, Transport Layer Security (TLS), Virtual Private Networks (VPN), and media encryption (SRTP).

These security requirements can place quite a burden on the computer infrastructure of a provider. As such, the primary challenge is to know which communications require extra security and which devices and network paths can provide it. As digital communication evolves, a variety of devices are likely to be found on networks providing varying levels of security. Determining an efficient way to route communications so that they receive the requisite security level is a difficult task. Thus, there is a continuing need for further advancements in the security and efficiency of digital telephony.

### SUMMARY

Various technologies and techniques are disclosed for selectively routing digital communications over a digital network comprising a plurality of network segments. A routing server receives a request for a digital communication session. The routing server then identifies a network route having a calculated route security score sufficient for the communication session requested. The routing server then notifies a gateway server of the selected route and allows the communication to be established along said route.

In one embodiment, the routing server receives a security level required score from a requesting digital telephone station. In a further form, the route security rating is calculated as a function of at least one security rating associated with a network segment. In a still further form, the route security rating is the minimum of the collective security ratings associated with the plurality of network segments which comprise the network route.

In yet another embodiment, the network endpoints under control of the routing server are each assigned a security rating. That rating may be based on the access level of the current user logged in, the security of the location of the network endpoint device, or the level of monitoring which occurs of the devices use. This allows for the protection of potentially sensitive information, such as from recording, transcription, or other wrongful dissemination.

This summary is provided to introduce a selection of concepts in a simplified form that are described in further detail in the detailed description and drawings contained herein. This summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one implementation.

FIG. 2 is a logical view of a table suitable for storing security ratings corresponding to network segments in one embodiment.

FIG. 3 is a process flow diagram demonstrating one example of the stages involved in routing a digital communication using the computer system of FIG. 1.

FIG. 4 is a logical view of a digital communication request utilized by the computer system of FIG. 1 in one embodiment.

FIG. 5 is a detailed process flow diagram demonstrating one example of the stages involved in selecting a network route as described in FIG. 3.

FIG. 6 is a detailed process flow diagram demonstrating one example of the stages involved in determining a route security score as described in FIG. 3.

FIG. 7 is a process flow diagram demonstrating one example of the stages involved in routing a digital user to a digital conference session using the computer system of FIG. 1.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

One implementation includes a unique system and methods for providing and maintaining communication trust scores for a plurality of network segments, including the function of ensuring that a digital communication occurs over a network path having the requisite security level, such as between a number of contact centers. It shall be understood that the principles of the present invention may also be applied to similar systems, such as by way of non-limiting example, a corporate telephony system.

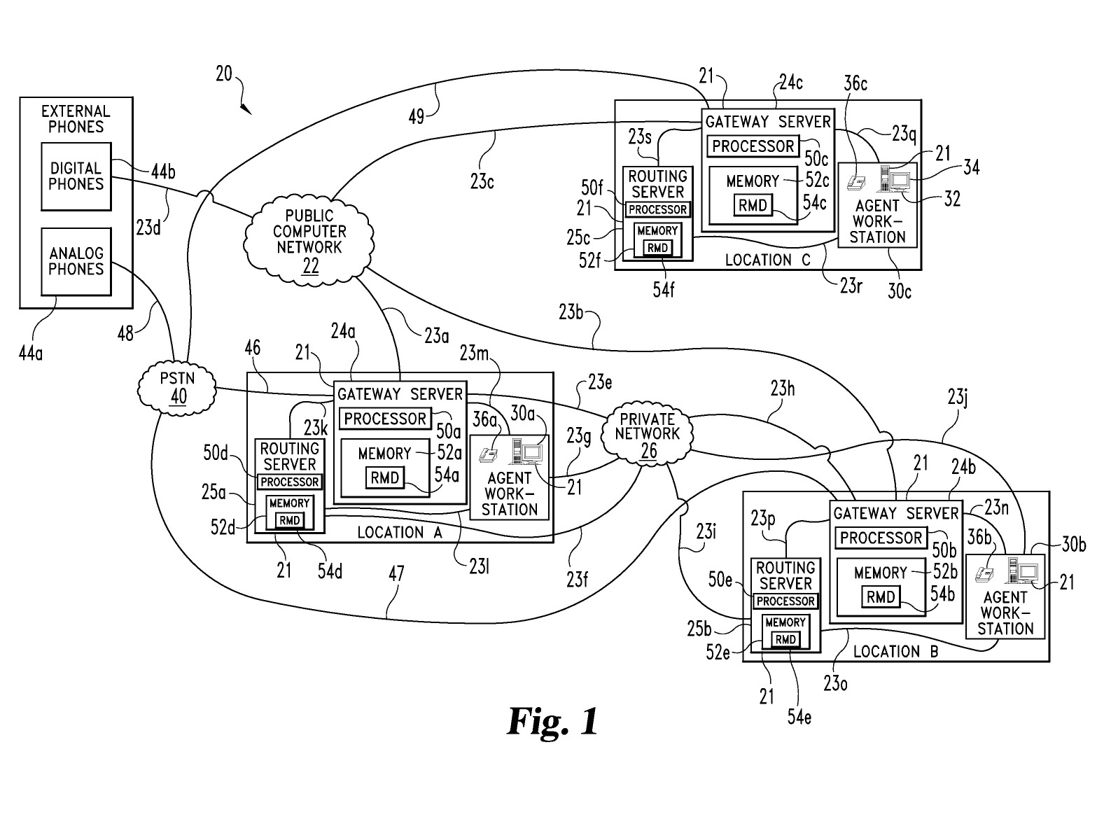

FIG. 1 is a diagrammatic view of computer system 20 of one embodiment of the present invention. The computer system 20 operates at a number of geographic or virtual locations, such as Location A, B, and C. Computer system 20 includes a number of computers 21, a computer network 22, and a private network 26. Computer network 22 couples together computers 21 over network pathways 23a, 23b, 23c, and 23d (collectively network pathways 23). Private network 26 connects location A and location B over a non-public network, such as an intranet or a virtual private network via network pathways 23e, 23f, 23g, 23h, 23i, and 23j. It shall be appreciated that private network 26 may connect any number of locations as determined by the particular embodiment, but that this arrangement is described for illustrative purposes only. Additionally, internal computers 21 and other network endpoints within each location are connected by additional network pathways 23k-23s.

More specifically, system 20 includes several servers, namely gateway servers 24a, 24b and 24c and routing servers 25a, 25b, and 25c, each located at location A, B, and C respectively. Locations A, B, and C may be situated in geographically distinct locations, may be logical divisions, or any combination of the two. System 20 also includes a plurality of client workstations 30a, 30b, and 30c. It shall be appreciated that each location A, B, or C may include one or more gateway servers 24, routing servers 25, or agent workstations 30, but that only one at each location has been shown to preserve clarity. Furthermore, although computers 21 are each illustrated as being a server or client, it should be understood that any of computers 21 may be arranged to include a client and server and/or that more or fewer may be utilized in alternative embodiments.

Gateway servers 24 and routing servers 25 include one or more processors or CPUs (50a, 50b, 50c, 50d, 50e, and 50f respectively) and one or more types of memory (52a, 52b, 52c, 52d, 52e, and 52f respectively). Each memory 52, includes a removable memory device (54a, 54b, 54c, 54d, 54e, and 54f respectively). Although not shown to preserve clarity, each computer 21 of computer system 20 includes one or more processors or CPUs and one or more types of memory. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or generic) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

System 20 further illustrates Public Switched Telephone Network (PSTN) 40 coupled to at least one gateway server, such as gateway server 24a, by pathway 46. External telephones 44, such as analog telephones 44a, may be coupled to the PSTN 40 by pathway 48. It should be understood that callers using analog telephones 44a will normally connect to the PSTN 40 by dialing a standard directory phone number, such as an “800” number corresponding to a contact center operated at Location A. The PSTN then sends a connection request to the gateway server 24a, which translates the request to a digital format for retransmission to a selected destination, such as agent workstation 30a. The client workstation 30a then establishes an audio connection with the PSTN, using gateway server 24a as the digital/analog conversion point.

Alternatively, other callers using external telephones 44, such as digital telephones 44b, have the option of bypassing both the PSTN 40 and the gateway server 24 and directly dialing the digital address of another gateway server 24 or the routing server 25 either of which may provide or be connected to call queue functionality. In this scenario, the digital telephone sends a connection request, such as a SIP invitation, to the routing server 25 via computer network 22. The routing server 25 then establishes a digital audio connection with the digital telephone 44b via network 22. The routing server 25 may then transfer the call to the appropriate destination, such as agent workstation 30a.

Workstations 30 each include a workstation computer 32 coupled to a display 34. Workstation computers 32 may be of the same type or a heterogeneous combination of different computing devices. Likewise, displays 34 may be of the same type, or a heterogeneous combination of different visual devices. It should be understood that while three workstations 30 are described in the illustrative embodiment, more or fewer may be utilized in alternative embodiments. Contact center applications of system 20 typically include many more workstations of this type at one or more physical locations, but only a few are illustrated in FIG. 1 to preserve clarity. In addition, in one form each workstation 30 can be configured as an agent workstation, a supervisor workstation, or as both an agent and a supervisor workstation. In an alternate form, each workstation 30 may be configured as a stand alone phone or workstation phone associated with a user, such as a business user.

Digital telephones 36a, 36b, and 36c are each associated with a different one of workstations 30a, 30b, and 30c, respectively. Additionally, digital telephones 36 may be integrated into the agent computer 32 and/or implemented in software. It should be understood that digital telephones 36, which are capable of being directly connected to network 22, may be in the form of a handset, headset, or other arrangement as would occur to those skilled in the art. It shall be further understood that the connection from computer network 22 to a workstation 30 can be made first to the associated workstation phone, then from the workstation phone to the workstation computer by way of a pass-through connection on the workstation phone. Alternatively, two connections from the network can be made, one to the workstation phone and one to the workstation computer. Although not shown to preserve clarity, each agent workstation 30 may also include one or more operator input devices such as a keyboard, mouse, track ball, light pen, and/or microtelecommunicator, to name just a few representative examples. Also, besides display 34, one or more other output devices may be included such as loudspeaker(s) and/or a printer.

Computer network 22 can be in the form of a Local Area Network (LAN), Municipal Area Network (MAN), Wide Area Network (WAN), such as the Internet, wireless network, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22 and private network 26. It should also be recognized that computer network 22 may additionally include one or more elements of PSTN 40.

In one embodiment, system 20 operates as a contact center at one or more physical locations that are remote from one another with routing server 25 being configured as a contact center server host, and workstations 30 each arranged as a contact center client host. It shall be understood that one or more gateway servers 24 may be included to distribute a communication load, but only one per location has been shown in FIG. 1 to preserve clarity. Also, one or more routing servers 25 may be configured as a contact center server host at one or more physical locations and may also be configured to provide, collectively or individually, the security features described herein. Furthermore, any of the computers 21 may be incorporated into other devices or located in geographically different locations from one another.

It shall be appreciated that if communication data is being sent to a digital device that is connected directly to network 22, no digital/analog conversion is required. As a non-limiting example, an outside caller using a digital phone may establish a direct digital communication stream with an agent workstation after being assigned to that agent by routing server 25. Both signaling and audio stream data between endpoints on network 22 may remain in a digital format. References to digital audio communications in the illustrative embodiment shall be understood to include all forms of digital telephony such as VOIP, SIP, and SRTP to name just a few representative examples. The present system and method may be applied to many other types of communications and their use within the current system and method is desired to be protected.

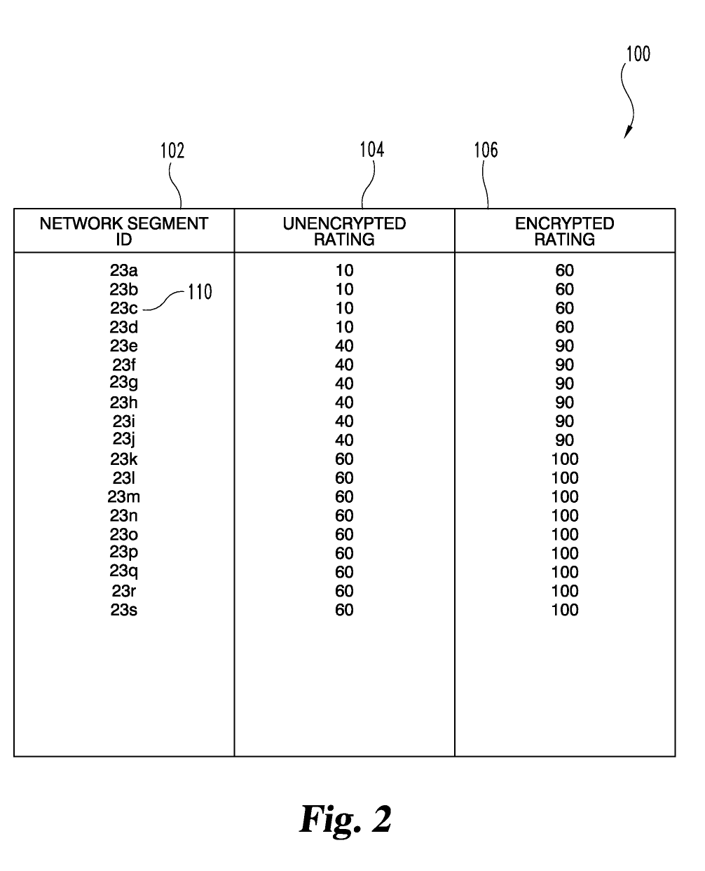

FIG. 2 illustrates a table 100 storing security level ratings for a number of the network segments of computer system 20. In the illustrative form, table 100 is populated dynamically using a variety of factors derived from each network segment, such as its location, owner, public accessibility, and protocol. In alternate forms, table 100 may be populated manually by one or more users or may be populated and optimized automatically, such as by artificially intelligent algorithms. In the illustrative embodiment, table 100 is stored electronically by routing servers 25 for use in determining network routes for digital communication sessions. In alternate embodiments, table 100 may be maintained by a central server, by gateway servers 24, or otherwise.

In the illustrative embodiment, table 100 includes column 102 which uniquely identifies each row associated with a network segment, column 104 for storing a security rating associated with unencrypted communication, and column 106 a security rating associated with encrypted communication. For purposes of illustration, the unique identifier entered in column 102 corresponds to those labels used in FIG. 1. However, in use the identifiers may be otherwise and may indicate or include the two endpoints connected by the network segment for purposes of route determination. Column 104 and 106 list security ratings associated with the network segment corresponding to each row. Column 104 is assigned based upon the security level of unencrypted communications occurring over the subject network segment, while column 106 corresponds to similar communications in encrypted form.

According to the illustrated embodiment, security ratings are assigned on a numerical scale from 0 to 100, with 0 being the least secure and 100 being the most secure. For example, row 110 represents network segment 23c connecting Location C to computer network 22. Computer network 22, in this embodiment, is a public computer network such as the Internet, and thus is not the most secure of all network possibilities. Communications over the Internet are subject to eavesdropping, packet sniffing, spoofing, denial of service attacks, etc. and are often difficult to prevent or trace, thus a low unencrypted rating of 10 is assigned. However, secure communication methods can alleviate many of these problems, with some amount of risk remaining; therefore a relatively strong security rating of 60 for secured communication is assigned. In alternate embodiments, security ratings may be numeric, alphanumeric, color coded, or otherwise. Additionally, table 100 may have only one security rating column for all types of communications, while in further forms table 100 may include even more columns, such as one security column and score for each of a varying number of encryption methods such as Secure Socket Layer (SSL) or Secure Real-Time Protocol Transport (SRTP).

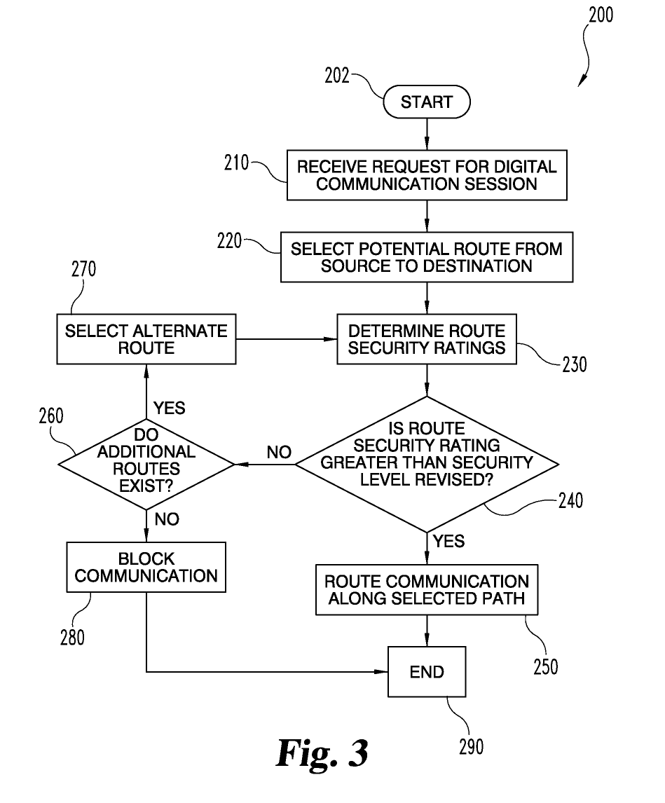

Turning to FIG. 3, with continued references to FIGS. 1-2, one embodiment for implementation with system 20 is illustrated in flow chart form as routing procedure 200, which demonstrates a process for routing a communication session over a selected network path having a sufficient security level as required by the communication session. In one form, procedure 200 is at least partially implemented in the operating logic of system 20 and more particularly gateway server 24 and routing server 25. Such logic can be in the form of software instructions, firmware instructions, dedicated hardware, or a combination of these. Procedure 200 begins at start point 202 with routing server 25 receiving a request for a digital communication session (stage 210). Utilizing the information provided in the request, routing server 25 determines a potential network route from source to destination (stage 220) for the pending communication to follow. In a further form, factors such as the key size of the encryption required may also serve as an additional selection criteria. Once a potential route is selected, routing server 25 utilizes table 100 to determine a route security rating for the potential route (stage 230). In an alternate embodiment, it may be desirable for the routing server 25 to determine a subset of possible routes and order them by security rating and pick the route with the lowest rating that is at or above the desired threshold. In this form, cost minimizations may be realized given the assumption that more secure routes include higher associated costs.

Returning to the illustrated embodiment, once a route is selected, routing server 25 compares the route security rating with the security level required for the digital communication session and determined if the potential route meets the communication session's security needs (stage 240). If the route security rating is greater than or equal to the security level required then the routing server 25 notifies gateway server 24 of the pending communication and gateway server completes the communication set up signaling using the supplied route and protocols (stage 250). In the event the communication session is connected, the process ends at end point 290. In an alternate form, in order to provide functionality, instead of just blocking the call if no route for the required rating is found, the routing server 25 may prompt the user whether they want to connect the communication at a lower available security level. In yet another embodiment, the downgrade may be automatic but accompanied by an aural and/or visual cue to the participants of the communication that the communication is proceeding with a lower security level, such as a soft tone/beep every 10 seconds.

In the event the potential network route's security rating does not meet the security level required by the pending digital communication in stage 240, the routing server 25 determines if additional network routes exist (stage 260). If additional routes do exist, the process proceeds to select an alternate route (stage 270). The additional route is then returned to stage 230 for route security rating determination. However, if additional network routes do not exist, then the communication is blocked (stage 280) and the process ends at end point 290.

Preferably, procedure 200 allows for the connection of a digital communication session in either an unencrypted or encrypted form. As illustrated by table 100 in FIG. 2, varying network segments may be assigned differing security ratings depending upon the encryption level of the communication. As such, a potential network path may be suitable, in that is has a sufficient security level rating, for handling a digital communication in encrypted form, while that same network path may not have a sufficient security level rating for handling the same communication in unencrypted format. This is based on the fact that encrypted security ratings are commonly higher than unencrypted security ratings for a network segment. As such, procedure 200 may retrieve two route security ratings during stage 230. During comparison of the route security ratings to the security level required in stage 240, routing server 25 may determine a route is suitable under encrypted communication but not under unencrypted communication and pass that information along as a requirement for the connection of a communication session to gateway server 24 along with the network route.

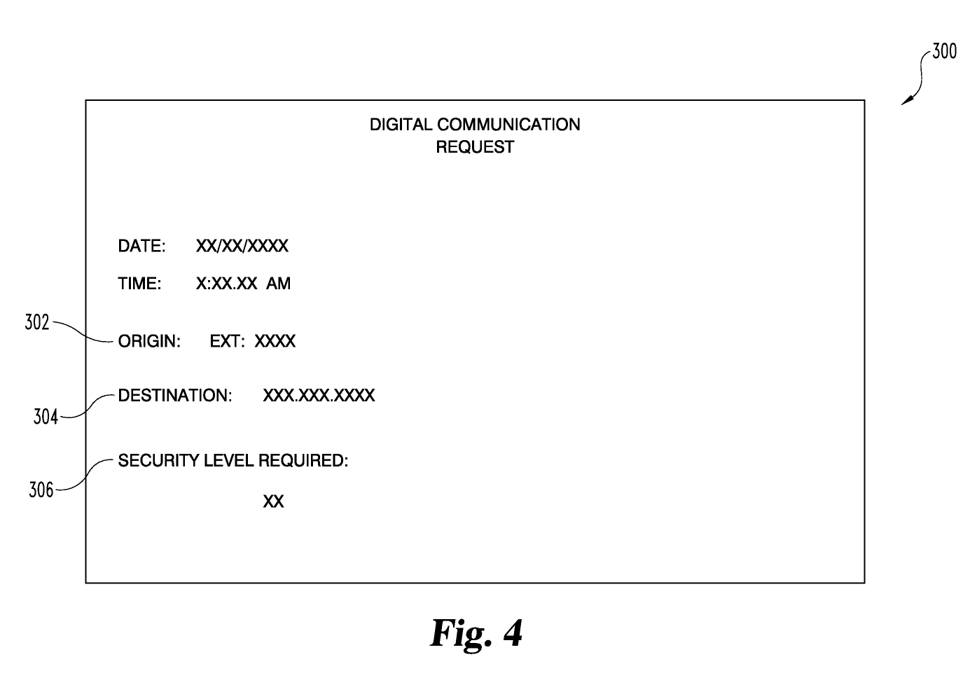

Turning to FIG. 4, one example of a digital communication 300 request is shown. The request includes information such as the origin 302, destination 304, and security level required 306. In the illustrated embodiment, the origin 302 is the extension or username/password combination corresponding to the requesting agent station. The destination 304 may be a traditional phone number or a network address. The security level required 306 is a numerical score calculated by a requesting agent station based upon the pending call information and subject matter. In an alternate form, security level required 306 may be determined by routing server 25 based upon a set of characteristics concerning the nature of the communication provided within request 300. In yet another form, the security level required 306 may be calculated by routing server 25 based upon the requesting user, their assigned group, or current operation stance. For example, a user operating in a queue and placing outgoing follow-up questionnaire calls may not require the same level of security as a CEO making an outgoing call.

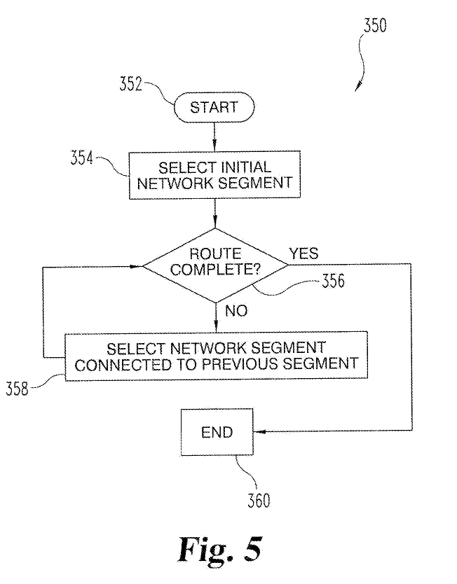

FIG. 5 illustrates, in flow chart form, a detailed process 350 according to one embodiment for selecting a network route according to stage 220 of FIG. 3. The process 350 beings at start point 352 with routing server 25 selecting a network segment connected to the origin of the communication session (stage 354). As described herein, the origin may be an agent workstation such as 30a, or more specifically, a digital telephone 36a. In many instances, this connection may be an Ethernet connection to a hub or router. However, the connection may include a wireless connection, such as 802.11 a/b/g/n, or a dial-up or other connection in the case of a remote user. Once the initial network segment is selected, the routing server 25 determines if the route is complete by checking the end of the route with the specified destination (stage 356). If the route is complete, the process 350 ends at end point 358. However, this will rarely be the case, as the route will need to be recursively built to include a number of network segments. As such, in the event the route is not complete from origin to destination the routing server 25 selects a new network segment connected to the end of the current network path (stage 358). Once the path has been amended with the newly selected network segment, the process 350 returns to stage 356 to determine if the route is complete. Preferably, routing server 25 maintains a listing of common network routes connecting common network endpoints for use in routing of digital communication sessions. By doing so, routing server 25 may automatically select the most preferred of efficient network sub-routes for construction of a necessary route. Additionally, in a further form, process 350 utilizes artificially intelligent algorithms to select routes.

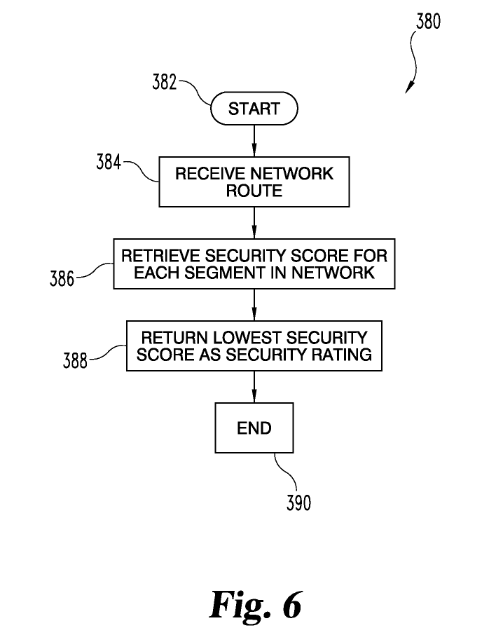

Referring to FIG. 6, a detailed process 380 according to one embodiment for determining a route security rating according to stage 230 of FIG. 3 is shown in flowchart form. The process 380 beings at start point 382 with routing server 25 receiving a potential network route (stage 384). Routing server then queries table 100, as described herein, for the security score assigned to each segment which comprises the potential network route (stage 386). Once the plurality of scores is returned, the routing server 25 returns the lowest security score of those assigned to the network segments in the route (stage 388). This model follows the theory that a chain is only as strong as its weakest length. Other theories known to those skilled in the art may be applied to determine the security level rating for a potential network route. Additionally, the length of the route may be a factor, or the number of devices the communication session will be handled by along the path. The process 380 ends at end point 390.

Turning to a further embodiment, the security rating of the each network endpoint involved in a digital communication may be required to meet the security level required by the digital communication request. That rating may be based on the access level of the current user logged in, the security of the location of the network endpoint device, or the level of monitoring which occurs of the devices use. This allows for the protection of potentially sensitive information, such as from recording, transcription, or other wrongful dissemination.

For example, returning to FIG. 1, a digital communication request may be initiated from agent workstation 30a to agent workstation 30b. The agent workstation 30a has a security rating of 100, while the agent station 30b is merely a readily accessible terminal within a contact center, and thus it only has a security rating of 50. The communication may concern highly confidential information, such as credit card and social security numbers, and thus have a high security level required of 80. As such, routing server 25a may determine a route over network segments 23g and 23j via private network 26 using an encrypted format to meet the security needs. However, in this embodiment, the route must include the network endpoint, which is agent station 30b. Upon including the security rating of the agent workstation 30b, then route security rating falls to 50 and the digital communication is blocked.

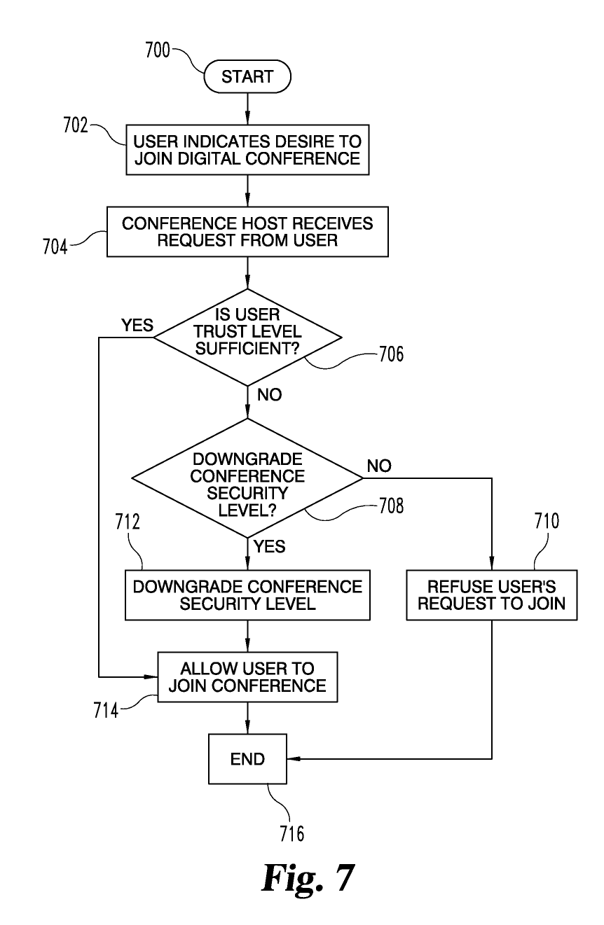

Turning to a digital multi-party conferencing embodiment, FIG. 7 illustrates the stages involved in routing and connection a user to a digital conferencing session. The process begins at start point 700 with the user indicating an intention to join a digital conferencing session (stage 702). The conference host receives the request from the device associated with the user including the route security rating associated with the user's route as well as the user's profile and associated device (stage 704). The host then determines if the trust level of the user if sufficient (stage 706), such as by comparing the user's proposed route security rating to the threshold set for the conference, comparing the user's own security rating associated with his/her profile with the conference security threshold, and/or by comparing the security rating of the device associated with the user's request to a security threshold. If the user does not meet any, all, or a selected subset of these criteria, the system provides the conference host with the option to lower the security level of the conference (stage 708), such as by consensus of the participants or unilaterally to allow the user to participate. Upon agreement of the conference host to lower the conference security level, the level is lowered (stage 714) and stored in the system. Should the host decline this option, the service denies the user's request to join the conference (stage 710) and may request that the user attempt to rejoin the conference at a higher security level, such as by utilizing a different route or device. In the event that the user meets the security level requirements of stage 706 the user is then connected to the digital conference (stage 714). The process ends at end point 716.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

What is claimed is:

1. A method for connecting a first party at a first network device to a second party at a second network device in a digital communication session comprising the steps of:
maintaining a database of security level ratings associated with a plurality of network segments;
receiving a notification at a server from said first network device corresponding to said digital communication session having an associated security threshold;
determining a network route connecting said first network device and said second network device comprising at least a first network segment selected from said plurality;
determining a route security rating as a function of at least said security level rating associated with said first network segment; and
blocking connection of said communication session over said network route if said route security rating is less than said security threshold.

2. The method of claim 1, further comprising the step of: connecting said first digital endpoint to said second digital endpoint over said route using said server if said route security rating is at least equal to said security threshold.

3. The method of claim 1, further comprising the steps of: sending a request from said server to said first party for permission to connect said communication session at a lower security threshold; and
connecting said first digital endpoint to said second digital endpoint over said network route using said server in response to a positive response received from said first party.

4. The method of claim 3, further comprising the steps of:
connecting said first digital endpoint to said second digital endpoint over said route using said server; and
presenting an indication of a less than desired security level to at least said first party prior to or during said communication session.

5. The method of claim 4, wherein said indication is presented in a display on said first digital endpoint.

6. The method of claim 4, wherein said indication is an audible indication presented to said first party prior to or during said communication session.

7. The method of claim 6, wherein said indication is presented periodically during said communication session.

8. The method of claim 1, further comprising the steps of:
connecting said first digital endpoint to said second digital endpoint over said route using said server; and
presenting an indication of a less than desired security level to at least said first party prior to or during said communication session.

9. The method of claim 1, wherein at least one of said security level ratings comprises a plurality of qualified ratings with an associated plurality of attributes.

10. The method of claim 9, wherein at least one of said attributes must be present in order for said qualified rating to be considered said security level rating of said network segment.

11. The method of claim 9, wherein all of said attributes have to be present for said qualified rating to be considered said security level rating of said network segment.

12. The method of claim 9, wherein one of said attributes indicates unencrypted communication traffic.

13. The method of claim 12, wherein one of said attributes indicates encrypted communication traffic.

14. The method of claim 13, further comprising the steps of:
determining a second route security rating associated with said network route as a function of at least said second rating associated with said first network segment; and
connecting said first digital endpoint to said second digital endpoint over said route in an encrypted form using said central server if said second route security rating is at least equal to said security threshold.

15. The method of claim 14, wherein said digital communication session is session initiated protocol (SIP) session.

16. The method of claim 15, wherein said security level ratings comprise numerical scores.

17. The method of claim 1, wherein said route security rating is the highest of the security level ratings associated with the network segments making up said network route.

18. The method of claim 1, wherein said route security rating is calculated as the minimum of the security level ratings associated with one or more network segments making up said network route.

19. The method of claim 1, wherein said security level ratings indicate the vulnerability of their associated network segment.

20. The method of claim 1, wherein said security threshold indicates a sensitivity level of said digital communication session.

21. The method of claim 20, wherein said security threshold is provided by a user.

22. The method of claim 1, wherein said first network device and said second network device are located at remote locations.

23. The method of claim 22, wherein said first network segment is the Internet.

24. The method of claim 1, wherein said digital communication session is a voice over internet protocol session.

25. The method of claim 24, wherein said digital communication session is session initiated protocol (SIP) session.

26. The method of claim 9, wherein one of said attributes indicates a particular encryption scheme.

27. The method of claim 26, wherein one of said attributes indicates SRTP communication traffic.

28. The method of claim 9, wherein one of said attributes indicates the security level associated with said first party.

29. The method of claim 28, wherein at least two of said attributes correspond to encryption schemes.

30. The method of claim 1, wherein said route security rating is determined at least in part upon a security rating associated with said first network device.

31. The method of claim 1, wherein said route security rating is determined at least in part upon a security rating associated with said second network device.

32. The method of claim 30, wherein said route security rating is determined at least in part upon a security rating associated with said second network device.

33. The method of claim 1, wherein said first and said second network devices are digital telephones.

34. The method of claim 32, wherein said first and said second network devices are digital telephones.

35. A method for connecting a first party at a first network device to a second party at a second network device in a digital communication session of comprising the steps of:
maintaining a database of security level ratings associated with a plurality of network segments, wherein said security level ratings include a first score corresponding to unsecured communication and a second score corresponding to secured communication;
receiving a notification at a server from said first network device corresponding to said digital communication session having an associated security threshold;
determining a network route connecting said first network device and said second network device comprising at least a first network segment selected from said plurality;
determining a first route security rating as a function of at least said first score associated with said first network segment; and
blocking said communication session in an unencrypted format if said first route security rating is less than said security threshold.

36. The method of claim 35, wherein said first route security rating is determined as a function of said first score associated with each network segment within said network route.

37. The method of claim 35, further comprising the step of connecting said first network device to said second network device in an unsecured communication session over said network route using said server if said route first security rating is at least equal to said security threshold.

38. The method of claim 36, further comprising the step of connecting said first digital endpoint to said second digital endpoint in an unsecured communication session over said network route using said server if said first security rating is at least equal to said security threshold.

39. The method of claim 35, further comprising the step of:
determining a second route security rating as a function of at least said second score associated with said first network segment; and
blocking said communication session in an encrypted format if said second route security rating is less than said security threshold.

40. The method of claim 39, wherein said second route security rating is determined as a function of said second score associated with each network segment within said network route.

41. The method of claim 39, further comprising the step of connecting said first digital endpoint to said second digital endpoint in a secured communication session over said network route using said server if said route first security rating is at least equal to said security threshold.

42. The method of claim 40, further comprising the step of connecting said first digital endpoint to said second digital endpoint in a secured communication session over said network route using said server if said route first security rating is at least equal to said security threshold.

43. The method of claim 41, wherein said secured communication session conforms to the SRTP protocol.

44. The method of claim 35, further comprising the step of:
sending a request from said server to said first network device for permission to connect said communication session at a lower security threshold; and
connecting said first network device to said second network device over said network route using said server in response to a positive response received from said first network device.

45. A data network for handling digital communications comprising:
a first and second network device, wherein each device is configured to send and receive digital communication packets;
a data network comprising a plurality of network segments connected to said first and second network devices;
a database connected to said data network maintaining a plurality of scores, each score corresponding to a network segment selected from said plurality; and
a server connected to said network, said server being configured to receive a network communication request having a security threshold from said first network device, determine a route comprising a selected number of said plurality of network segments, wherein said route is determined based upon said plurality of scores and said security threshold, and connecting said first and said second network devices in a digital communication session.

46. A method for connecting a first party associated with a first network device to a second party associated with second network device in a digital communication session comprising the steps of:
maintaining a database of security level ratings associated with a plurality of network segments and user security ratings associated with at least said first and said second parties;
receiving a notification at a server from said first network device corresponding to said digital communication session having an associated security threshold;
determining a network route connecting said first network device and said second network device comprising at least a first network segment selected from said plurality;
determining a route security rating as a function of at least said security level rating associated with said first network segment; and
blocking connection of said communication session over said network route if any of said route security rating, said user security rating of said first party, or said user security rating of said second party is less than said security threshold.

47. The method of clam 46, wherein said second user is logged into said second device.

48. The method of clam 47, wherein said first user is logged into said first device.

49. The method of claim 48, further comprising the step of:
selecting a third network device accessible to said second party having a second route from said first network device having a security rating greater than said security threshold;
notifying said second party of an incoming communication on said third device;
receiving a notification that said second party is associated with said third device; and
connecting said first device and said third device in a digital communication session over said second route.

50. A method for connecting a first party associated with a first network device to a digital conference comprising the steps of:
maintaining a database of security level ratings associated with a plurality of network segments and user security ratings associated with at least said first party;
receiving a notification at a server from said first network device corresponding to a request to join said digital conference;
receiving a security threshold associated with said digital conference;
determining at least one network route connecting said first network device to said digital conference comprising at least a first network segment selected from said plurality;
determining a route security rating as a function of at least said security level rating associated with said first network segment; and
blocking connection of said communication session over said network route if either of said route security rating or said user security rating of said first party is less than said security threshold.

51. The method of claim 50, further comprising the steps of:
selecting a second network device accessible to said first party having an second route to said digital conference having a security rating greater than said security threshold;
inviting said first party to join said digital conference from said second device;
receiving a notification that said first party is associated with said second device; and
connecting said second device to said digital conference using at least said second route.

52. The method of claim 50, further comprising the steps of:
sending a request from said server to a participant in said digital conference to allow said first party to join said digital conference at a lower security threshold; and
connecting said first network device to said digital conference over said network route using said server in response to a positive response received from said participant.

53. The method of claim 52, wherein said participant is a moderator of said digital conference.
